(19) United States
(12) Patent Application Publication
(10) Pub. No.: US 2019/0032552 A1
(43) Pub. Date: Jan. 31, 2019

(54) AVIATION GASOLINE ENGINE COOLANT INJECTION SYSTEM

(71) Applicant: Swift Fuels, LLC, West Lafayette, IN (US)

(72) Inventors: Chris D'Acosta, West Lafayette, IN (US); Brian Stirm, Delphi, IN (US); Thomas Albuzat, Homburg (DE)

(21) Appl. No.: 16/047,580

(22) Filed: Jul. 27, 2018

Related U.S. Application Data
(60) Provisional application No. 62/537,725, filed on Jul. 27, 2017.

(51) Int. Cl. F02B 47/02; F02C 3/30

(52) U.S. Cl. CPC F02B 47/02; F02B 3/08; F02C 3/30

(57) ABSTRACT

A set of apparatus to inject distilled-water in solution acting as an engine coolant into the combustion chamber of a high-compression air-cooled piston aircraft engine to mix with aviation gasoline, operating on a minimum 91 motor octane aviation gasoline (leaded or unleaded), thereby improving engine performance, and suppressing early detonation in prescribed operating situations. The apparatus incorporates 1) an ultra-light weight corrosion-resistant engine coolant storage compartment mounted inside the aircraft, 2) stainless steel pipe fittings, 3) controller activated fluid injectors with wide spray nozzles, 4) aircraft-approved wiring and stainless steel plumbing tied to the pump and combustion chamber, 5) a primary and back-up electric pump approved for aviation use, 6) a special formulation of water-based cooling fluid in solution with a non-toxic anti-freezing agent designed for high altitude aircraft use, 7) electric sensors for temperature, pressure and early detonation programmed to a sensory control unit that automatically activates the electric pump to inject coolant only on pre-configured conditions during periods of peak engine performance when early detonation is most likely to occur, 8) a is digital metering display for the pilot instrument panel capable to report cylinder-head temperature, manifold pressure, oxygen (air/fuel ratio) and an aviation approved knock-sensor, and 8) a test switch and automatic operation on-off switch.

### CROSS-REFERENCE TO RELATED APPLICATION

This application claims the benefit of U.S. Provisional Application No. 62/537,725 filed Jul. 27, 2017, which is hereby incorporated by reference.

### BACKGROUND

The internal combustion engine marketplace has utilized various water/alcohol injection techniques to reduce the risk of early detonation (knocking) in engines for many decades. The clear majority of these systems were designed for internal combustion engines using automotive gasoline (designed originally for low octane fuels up to more recent ethanol-free gasolines with octane rated at 91 AKI) operating in ground vehicles. These knock suppression techniques, when considered for use in high-compression piston engine aircraft flying at high altitude, require unique configurations as outlined in this invention. For example: to not add excessive weight to the aircraft, or introduce corrosion issues to the fuel system, or expose pilots to toxic fumes in the cockpit, or introduce unfiltered particulates into the combustion chamber of the engine that can form deposits and the injection system may fail to adequately impact combustion behavior. Furthermore, prior to this invention, no other application was designed to utilize ASTM-approved unleaded aviation gasoline with minimum motor octane of 91 MON (98+ AKI) in high-compression, horizontally-opposed piston-engine aircraft. This invention addresses specific shortfalls of these prior methods and brings a unique perspective to the challenge of maximizing engine performance specifically at take-off and climb conditions in horizontally-opposed piston aircraft while also achieving lower exhaust emissions, a cleaner burn and full detonation suppression thoughout flight using aviation gasoline with an engine cooling technique introduced into the combustion chamber specifically for higher-compression piston aircraft.

Internal combustion engines in piston aircraft differ greatly from those in automobiles.

Automobiles utilize a high rpm transmission with a gear reduction system, where piston aircraft do not have a transmission but instead have a much larger crack shaft and thrust bearings to directly rotate the propeller.

Automobiles utilize water-cooled cylinders which are maintained at a constant temperature for stable operation, whereas piston aircraft cylinders are air-cooled by the inflow of outside air controlled by the pilot's throttle. Detonation will occur in the aircraft engine when the cylinder gets too hot, which can be impacted by high outside air temperature and/or slow speeds at too high a deck angle. Certain pilot operating conditions may not lend themselves to lowering the angle of ascent, which is why either cooling the inlet air or cooling the cylinder or increasing the octane of the fuel is critical to prevent detonation.

It is also noteworthy that automobile engines of today are now highly automated whereby the air-to-fuel ratio is maintained at a constant level, adjusted for octane, while piston aircraft are operated manually at rich and lean mixture configurations subject to pilot discretion.

Automobiles are generally operated up to about 30% of their rated power where piston aircraft are generally operated above 75% of their rated power. This infers that piston aircraft are much more vulnerable to detonation incidents because full power is needed at take-off and cross-country cruise is generally at about 75% power. Accordingly, there are few options to safely lessen the load on the aircraft engine at full power during take-off to avoid detonation.

Automobiles use smaller spark plugs with a typical bore size of 2″ to 4″ while most piston aircraft use larger horizontally-opposed spark plugs (2 in each cylinder) with bore sizes between 3″ to 6″. Automobiles have engine rotation speeds ranging from 0-7,000 rpm while piston aircraft typically have a maximum rotation of about 2,700 rpm. This directly impacts the detectable sound (i.e. at different frequencies) that sensors may hear detonation vibrations.

In the last several decades the compression ratio of most engines, measuring the ratio of the max vs. min volume in the cylinder, ranges between 9:1 to as high as 14:1 for automobiles, while such ratios on high performance aircraft are lower, typically ranging between 7.5:1 up to 9:1 (with naturally aspirated engines having ratios the higher end, turbocharged engines at the lower end.)

All these factors and more impact the way fuel is combusted and engine detonation (knock) is controlled—particularly when adding the complexity in aircraft at high altitudes needing low vapor pressure gasoline with very high octane levels to sustain peak performance.

### SUMMARY

The engine coolant storage compartment—the water-based coolant storage reservoir has a fluid storage capacity between 2 to 8 gallons and must be either metered (e.g. level sensor) or with a visible fluid level to allow the aircraft operator to see the fluid level during pre-flight activities. The preferred material of construction is either stainless steel (although this adds cost and weight), non-corrosive aluminum or reinforced plastic, high-density polyethylene, fiberglass, or some other durable light weight composite-like material approved for use with water, alcohols, ethers, or solvents. Any such material must comply with all Federal Aviation Regulations (FAR). The storage compartment will fit snugly at the rear of the baggage compartment, wing locker or similar area, secured firmly to the aircraft structure to withstand extreme forces. The storage reservoir when empty should not exceed 6 pounds making the total weight when filled with coolant between 20 to 64 pounds, which is within the existing weight tolerance of the aircraft. Many available materials can be utilized for construction of the reservoir, however, examples of such ultra-light materials with the highest tensile strength include epoxy novolac polyester resin, corrosion-resistant fiberglass reinforced plastic, epoxy vinyl ester urethane resin, low VOC resins, carbon fiber composites. All the non-metallic materials can be made with a visible level and can be molded for transporting coolant liquids safely with high impact resistance. Due to their propensity to rust and their excessive weight, carbon steel storage reservoirs are not desirable in this application.

The pipe fittings, injectors, spray nozzles, wiring and plumbing—in this invention all piping, fluid injectors, coolant plumbing and liquid connectors will be stainless steel to maintain a stable and corrosion-free configuration. The plumbing and wiring (typically Teflon coated) will comply with piston aircraft FAR safety regulations. A sample diagram is shown attached.

The electric pumps and diaphragm—in this invention the coolant injectors are activated using solid state electric boost pumps. These pumps must be anti-corrosion design and aviation approved (e.g. Gold-flo solid-state interrupter pumps). The operational features include a minimum flow rate of 12 gallons per hour, 24 volts, average 2-8 psi, 1.3 amps operation with a weight not to exceed . . . lbs., corrosion resistant and operational up to −40° F. For long-lasting service, the pump diaphragms and O-rings are most cost effective using Viton or Teflon style materials. The pump installation must not weight more than > > > lbs.

The water-based engine coolant solution—in this invention the water-based coolant solution is a unique blend comprised of distilled water in solution with low-toxicity ethanol (sometimes denatured) with a flash point above 10° C. In some applications, the solution has specialized additives such as anti-corrosion, anti-microbial and/or anti-freezing agents, an octane booster, a detergent, a synthetic soluble lubricant and dyes. This formulation provides a low-toxicity solution which is impervious to freezing at high altitudes, maintains an effective viscosity (min liquid flow at . . . gph), and operates effectively at low atmospheric pressures consistent with the vapor pressure of the coolant above 12,000 feet. Furthermore, the formulation in this invention will not introduce unwanted particulates into the combustion chamber which might corrode the fuel intake area or clog spray nozzles or otherwise create deposits in the combustion chamber. Note that methanol is explicitly omitted from use due to its higher environmental toxicity and its tendency to be highly corrosive. Due to the high variations in lubricant products available in the marketplace and their performance properties, mineral-based motor oils (engine lubricants) and soluble oils used in metal working are explicitly not approved as a coolant additive in this invention.

In one embodiment, the solution was 60% distilled water and 40% denatured ethanol with 400 ppm synthetic lubricant and a red dye.

In another embodiment, the solution was 70% distilled water and 30% ethanol with 800 ppm semi-synthetic lubricant.

In another embodiment, the solution was 50% distilled water and 50% denatured ethanol with an anti-corrosion additive (200 ppm) and a poly-alpha-olefin lubricant (200ppm).

In one embodiment, the solution was 90% distilled water and 10% ethanol with isopropyl alcohol as an anti-freezing additive (500ppm) with 400 ppm synthetic lubricant and a red dye.

In one embodiment, the solution was 100% ethanol with an anti-corrosion additive (200 ppm), an anti-microbial agent (200 ppm) and an anti-oxidant agent (200 ppm).

In the preferred embodiment, the use of distilled water in the solution has the following properties that make it most desirable as an engine coolant, while being a low-toxicity solution for pilots to manually refill the reservoir in the rear seating area of the aircraft:

The amount of total dissolved solids (TDS) is <10 mg/l (ppm)

There are no detected inorganic chemicals (e.g. arsenic, bromate, fluoride, lead, mercury, nitrates)

There are no detected secondary inorganic compounds (e.g. chloride, copper, manganese, sulfate, zinc)

There are no detected Volatile Organic Compounds (e.g. Toluene, Xylene, Trihalomethanes, ethylbenzenes, etc.)

There are no detected synthetic organic compounds (e.g. carbofuran, chlordane, ethylene dibromide, oxamyl, picloram)

There are no detected regulated contaminates (i.e. MTBE, Naphthalene, 1,1,2,2-Tetrachloroethane)

The color, turbidity and odor are not detectable

The coolant solution in this invention is fully soluble with distilled water and has a freeze point at or below −40° F. (−40° C.). The solution as designed is not corrosive or vulnerable to oxidize during long periods of inactivity and does not promote microbial growth. Based upon testing of various components, the ideal mixture is one that maximizes the use of distilled water while meeting all the other performance requirements. The preferred color of the coolant is dyed red—making the level clearly visible from outside the reservoir.

| ID | Coolant | Freeze Pt | Density | | Flash Point | H2O Solubility | Energy Content | AKI Rating |
|---|---|---|---|---|---|---|---|---|
| B | Distilled Water | 0° C. | 1,000 | kg/m3 | — | — | — | — |
| C | Ethanol | −114° C. | 789 | kg/m3 | 17° C. | miscible | 21.2 MJ/L | 115 AKI |
| D | Methanol | −98° C. | 792 | kg/m3 | 12° C. | miscible | 17.9 MJ/L | |
| F | Ethylene Glycol | −12° C. | 1113 | kg/m3 | | | | |
| G | Propylene Glycol | −59° C. | 1036 | kg/m3 | | | | |
| H | Isopropyl alcohol | −89° C. | 786 | kg/m3 | 12° C. | miscible | 38.4 MJ/L | |
| — | Aviation Gasoline | −60° C. | 700 | kg/m3 | 0° C. | immiscible | 33.5 MJ/L | |
| Mix | 20% B + 80% C (vol) | −59° C. | | | | | | |
| Mix | 40% B + 60% D (vol) | −59° C. | | | | | | |
| Mix | 40% B + 60% F (vol) | −45° C. | | | | | | |
| Mix | 40% B + 60% G (vol) | −48° C. | | | | | | |

The digital meter pilot display—in this invention, the display unit reports the cylinder head temperature, the manifold pressure, and any positive detonation event (a red light) on a single display unit. A second and possible a third display report the fuel/air ratio (i.e. a lambda sensor) with both digital readout and an analog meter. The oxygen sensor is placed in the aggregate exhaust channel, with two such exhaust channels on twin engine aircraft—hence the need for two oxygen display meters in this case. The display unit is mounted on the cockpit for pilot ease of use. This display also controls the on-off switch and the pilot test capability.

The sensor unit controller—in this invention, the coolant injection pump can be manually activated or automatically activated by an algorithm managed by the unit controller. Prior to take-off, a manual check of the coolant injection system can be triggered by the pilot at which point there will be a pronounced drop in RPM as the engine is cooled by the injected coolant—confirming proper operation. At this point the pilot can set the control unit to “automatic” which is programmed and configured by engine type to trigger the activation of the coolant injection pump, for example at one of the following conditions:

An early detonation reading is sensed—which automatically activates the pump

The cylinder head temperature (CHT) exceeds 400° F.—which automatically activates the pump

The manifold absolute pressure (MAP) exceeds 25 in Mercury—which automatically activates the pump

When any of these conditions does not exist, the sensor control unit will not activate the pump. The back-up pump is wired to support a primary pump failure.

When activated, the pump generates a continuous stream of coolant, a spray mist to mix with the gaseous fuel vapors, into the combustion chamber lasting 120 seconds and will repeat this pattern until all the operating conditions return to normal.

### BRIEF DESCRIPTION OF THE DRAWINGS

FIG. 1 is a diagram of an exemplary apparatus.

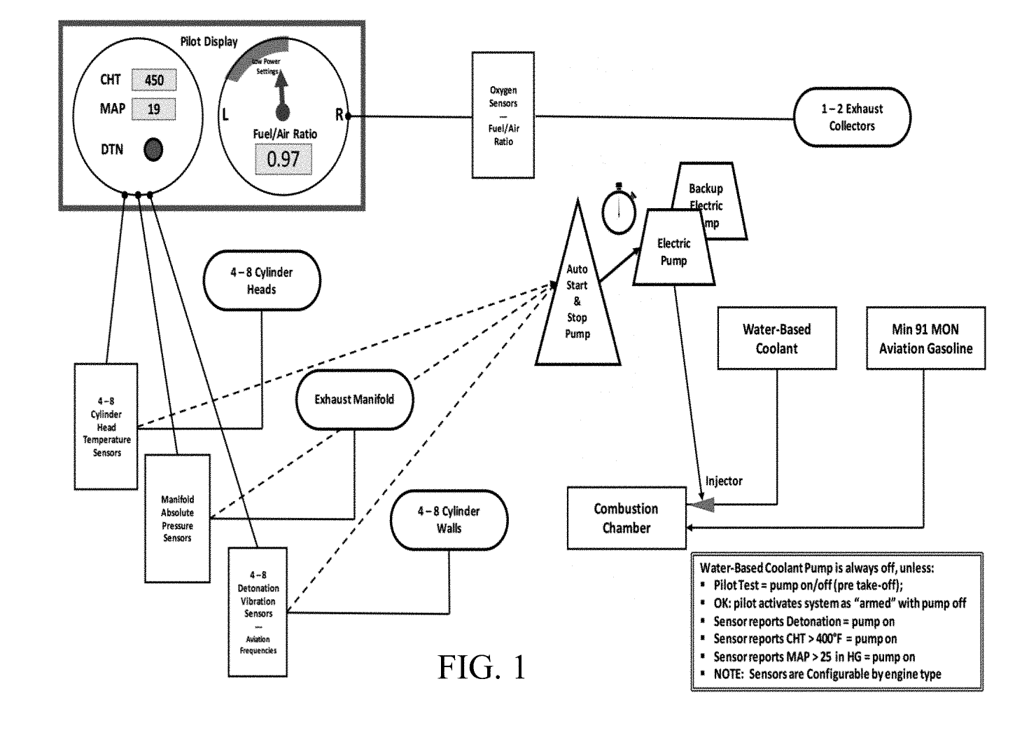

1. An apparatus to inject distilled-water into the combustion chamber of a high-compression air-cooled piston aircraft engine, said apparatus including: an ultra-light weight corrosion-resistant engine coolant storage compartment; stainless steel pipe fittings; controller activated fluid injectors with wide spray nozzles; aircraft-approved wiring and stainless steel plumbing tied to the pump and combustion chamber; a primary and back-up electric pump; a water-based cooling fluid in solution with a non-toxic anti-freezing agent; electric sensors for temperature, pressure and early detonation detection; a digital metering display for the pilot instrument panel capable to report cylinder-head temperature, manifold pressure, oxygen (air/fuel ratio) and an aviation approved knock-sensor; and a test switch and on-off switch.
